(19) United States
(12) Patent Application Publication
(10) Pub. No.: US 2026/0237840 A1
(43) Pub. Date: Aug. 13, 2026

(54) BATTERY STORAGE DEVICE

(71) Applicants: LG Energy Solution, Ltd., Seoul (KR); AVL LIST GMBH, Graz (AT)

(72) Inventors: Bernhard SIFFERLINGER, Graz (AT); Simon ERKER, Graz (AT); Bernhard BRUNNSTEINER, Graz (AT); Roland MACHERHAMMER, Graz (AT); Karl AUFDERKLAMM, Gratkorn (AT); Matthias Peter HANDL, Graz (AT); Seyun JUNG, Seoul (KR); Inje LEE, Gyeonggi-do (KR); Sungwon SEO, Seoul (KR); Jongmo KANG, Daejeon (KR); Taewon HWANG, Daejeon (KR)

(21) Appl. No.: 19/156,333

(22) PCT Filed: Feb. 15, 2024
(86) PCT No.: PCT/AT2024/060052

§ 371 Date: Aug. 13, 2025

(30) Foreign Application Priority Data
Feb. 16, 2023 (AT) A 50102/2023

(51) Int. Cl. H01M 50/383; H01M 50/211; H01M 50/30

(52) U.S. Cl. CPC H01M 50/383; H01M 50/211; H01M 50/394

(57) ABSTRACT

The present invention relates to a battery storage device (100), in which a sealant (40) is arranged at a through-opening (13) which passes through a housing (10) and through which a busbar (30) passes between an interior (12) and an outer side (17) of the housing (10).

The present invention relates to a battery storage device, in which battery cells are received, with a defined discharge for a possible gas release from the battery cells.

The battery storage device is used as a battery module in a modular structure of a battery storage device, which is used, for example, in mobile applications such as a traction battery in a vehicle.

Modular battery storage systems are known, which have a high energy density and require particular safety features in order to avoid as far as possible a spreading chain reaction among the battery cells, i.e. a thermal runaway, as can occur in some combustible, active materials in lithium-ion batteries. These safety features include a ventilation system, which allows hot exhaust gases and their thermal load to be discharged outwards in a manner that is as controlled as possible.

If the battery storage system is located on board a vehicle, in particular in the immediate vicinity of a passenger compartment, there are also further safety provisions with regard to a permissible thermal load that is discharged to a limited extent by exhaust gas in the system surrounding area of the vehicle, such as in particular a maximum temperature or the avoidance of flying sparks caused by glowing particles that can cause gases to ignite.

On the other hand, there is always a desire in vehicle construction to optimise space, weight and cost, which limit the design freedom for constructive solutions that are relevant to the mentioned, safety-related treatment of gas releases and waste heat in thermally critical incidents. Accordingly, there is a fundamental need for a design to improve the thermal behaviour of battery storage systems.

It is an object of the invention to configure and develop a battery storage system in such a manner that the safety of passengers is improved if gas releases are vented from thermally overloaded battery cells in the battery storage system.

The above object is achieved by a battery storage device having the features of claim 1. Further features and details of the invention can be found in the dependent claims, the description and the drawings.

The battery storage device according to the invention comprises a housing for receiving a number of battery cells and at least one gas exit opening, which is arranged on the housing and which serves to expel gas releases from the battery cells from an interior of the housing to an outer side of the housing. Likewise, the battery storage device has at least one busbar for the common electrical connection of the battery cells in the housing with a potentional electrical connection, which is arranged on the outer side of the housing. According to the invention, a sealant is arranged in particular at a through-opening which leads through the housing and through which the busbar passes between the interior and the exterior of the housing.

The invention thus provides for the first time a seal in an exit region of a busbar from a housing. This closes the exit region of the busbar in a gas-tight manner. If there is a gas release from a battery cell, it can be ensured, on the one hand, that no exhaust gas escapes in an uncontrolled manner from the housing via the through-opening of the busbar. Insofar as the housing has no further functional openings apart from the gas outlet, it can also be ensured that the hot exhaust gas is discharged from the housing of the battery storage system exclusively via the gas outlet in a controlled manner.

The term “sealant” as used in the present disclosure defines a curing mass consisting of a filler and a binder that adheres to surfaces of suitable materials, forms its own closed, sealing surface and thus ensures a sealing property over elements located therebelow against the escape of a gas.

A major advantage of the invention is that it provides a condition for allowing a gas release, i.e. a venting gas, to escape from the housing with defined, directed guidance in the event of thermal spread. In this context, further advantages of the invention lie in the fact that the hot exhaust gas flows exclusively via a segment provided specifically for this purpose, possibly with a cooling-effect configuration, in a controlled manner to the gas outlet and does not escape from the housing via another opening for the wiring of the battery cells. As a further consequence, the spread of critical temperatures to adjacent battery cells in the battery storage system and a possible thermal chain reaction among the battery cells can be suppressed as far as possible.

According to an advantageous aspect of the invention, the sealant can be in contact with an inner surface of the housing in a region surrounding the through-opening, and enclose the busbar in the housing. Thus, the through-opening is closed from at least one inner side of the housing. If a sufficiently large region around the through-opening is selected, the sealant can, advantageously in terms of manufacturing technology, be processed relatively insensitive to tolerances and be applied easily accessible from only one side on the housing, whereby a sufficiently tight seal is achieved.

According to an aspect based thereon or an alternative aspect of the invention, the sealant can fill a circumference of the through-opening and enclose the busbar in the through-opening. Thus, the housing is sealed in a circumferential gap between the through-opening and the busbar in the through-opening itself. If the sealant is applied only within the through-opening, a sufficiently tight seal can be achieved in a cost-saving manner by using little material.

According to a further aspect of the invention, the busbar can be arranged in a housing section between the plurality of the battery cells in the interior of the housing and a housing wall. Thus, the sealing region expands both in its extension and functionally in relation to the housing.

According to yet a further aspect of the invention, the sealant can substantially fill the housing section and substantially enclose the busbar and seal the interior of the housing in a gas-tight manner with respect to the outer side. This can also ensure that the potentially combustible gas does not come into contact with the busbar, which has already heated up to ignitable temperatures and can glow during a thermal incident in the relevant battery cell due to its thermal conductivity. Accordingly, ignition of a combustible exhaust gas by direct contact with a hot busbar can be avoided. For example, the sealant can fill an outer housing section up to the housing wall, to seal the interior of the housing with respect to the housing section in which the busbar is arranged. By sealing a larger region around the busbar, which includes the through-opening, ignition of a combustible exhaust gas in connection with a high temperature of a busbar is reliably excluded.

According to an advantageous aspect of the invention, the housing can be composed of at least two housing elements at a component boundary, and the sealant can be in contact with an inner surface of the housing in a region enclosing the component boundary. Thus, a gas-tight seal of the housing to an inner side of the component boundary between the housing elements is achieved.

According to an aspect based thereon or an alternative aspect of the invention, the housing can be composed of at least two housing elements at a component boundary, and the sealant can be arranged between opposite boundary surfaces of the housing elements. This optionally or additionally achieves a gas-tight seal of the interior of the housing at the component boundary between the housing elements.

According to an advantageous aspect of the invention, the sealant may comprise an inorganic, in particular mineral filler. Said mineral filler is inexpensive and easily available.

According to an advantageous aspect of the invention, the sealant may comprise a silicon oxide-based ceramic composite. This increases the strength of the sealing layer.

According to an advantageous aspect of the invention, the sealant may comprise a high temperature-resistant binder. A binder is preferably selected that is non-combustible after curing at temperatures above 1000° C.

According to an advantageous aspect of the invention, the sealant may have an adhesive property or be an adhesive. This ensures the integrity of the seal on the housing elements, the adhesion of which also withstands mechanical influences such as vibrations or similar in mobile applications.

According to an advantageous aspect of the invention, the sealant can have an electrically insulating property. This prevents a short circuit from occurring between the busbar and housing parts that are enclosed and contacted by the seal.

Further advantages, features and details of the invention can be found in the following description, in which exemplary embodiments of the invention are described in detail with reference to the drawings. In this case, the features mentioned in the claims and in the description may be essential to the invention individually or in any combination. They show schematically:

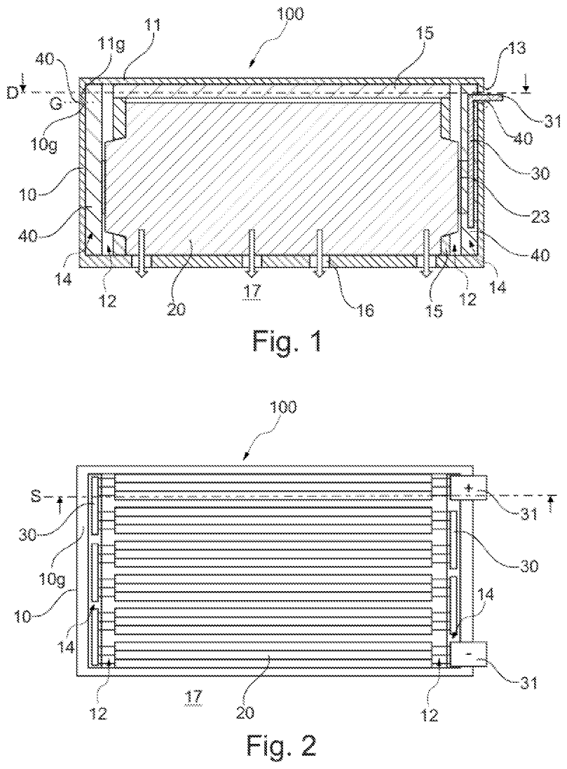

FIG. 1 a schematic side sectional representation of a modular battery storage device according to one embodiment of the invention,

FIG. 2 a schematic top view of an open battery storage device according to the same embodiment of the invention.

FIG. 1 schematically shows a side sectional view of a modular battery storage device 100 in a vertical plane S, the course of which is marked in FIG. 2. FIG. 2 shows orthogonally to FIG. 1 a schematic top view of an open state of the battery storage device 100 in a horizontal plane D, the course of which is marked in FIG. 1.

The battery cells 20—here represented as pouch cells by way of example—are received in an interior 12 of a housing 10. On the sides shown on the left and right, the battery cells 20 are held and fixed in the housing 10 via a carrier 15 made of a ceramic material.

A plurality of adjacent battery cells 20 are combined into groups and electrically connected to one another within the group via cell contacts 23 in parallel connection to busbars 30. The groups of the battery cells 20 are in turn electrically connected to one another via the busbars 30 in series connection. At the outer groups of battery cells within the housing 10, wiring of the battery cells 20 ends in potential connections 31 with a positive and a negative potential, which represent the electrical connection poles of the modular battery storage device 100. A plurality of these modular battery storage devices 100 in turn form a larger battery storage system, such as for example a traction battery of a vehicle or the like. For providing the connections 31, the busbars 30 of the relevant outer groups of battery cells 20 protrude from the housing 10 via a respective through-opening 13.

On an underside of the housing 10, i.e. on a bottom of the interior 12, there are arranged gas exit openings 16, which are assigned to the groups of battery cells 20. In the event of an ignition or a similar thermally critical incident that causes a gas release, i.e. escaping exhaust gases from a battery chemistry in the battery cells 20, the gas can escape downwards from the interior 12 as part of a pressure reduction through the gas exit openings 16—represented by the arrows. In an exhaust gas guidance system not shown here, the gas is expelled via bypasses, which lead to a cooling of the gas temperature, to an outer side 17 or a surrounding area of the battery storage device 100.

In the outer housing sections 14 of the housing 10 on the left and right sides as shown, a sealant 40 is introduced which fills the outer housing sections 14 of the housing 10 and in doing so encloses the wiring of the busbar arrangement 30 up to the through-openings 13. The sealant 40 is in contact with the inner walls of the housing 10 and fills a surrounding area around the through-openings 13 in such manner that the through-opening 13 is enclosed in a gas-tight manner. Thus, a volume of the interior 12 of the housing 10 is sealed against an exit of gas by way of the sealant in the housing sections 14 to the left and right side, and venting is only possible in a controlled manner through the provided gas exit openings 16, preferably into a housing section, not shown here, for further exhaust gas treatment. Furthermore, the sealant 40 provides a thermal barrier between the busbars 30 and the volume of the interior 12.

The sealant 40 is preferably an inorganic, high temperature-resistant one-component adhesive such as those used for sealing flame barriers. It is suitable for bonding metals and other materials with low absorption, comprises a ceramic composite material and is temperature-resistant up to 1100° C., in particular non-combustible.

In the top view in FIG. 2 of an upper side of the open battery storage device 100, a housing cover 11 of the housing 10 and the carrier 15 for fixing the battery cells 20, which are visible from above, are removed. Similarly, the outer housing sections 14 are not yet filled with the sealant 40, with the conductor structure as well as the connections 31 of the busbar 30 being visible from above.

The sealant 40 can be introduced into the outer housing sections 14 when combining the modular battery storage device 100 before or after inserting and connecting the conductor structure of the busbars 30. The filling of the sealant 40 is in contact with an inner surface of the housing 10 at least in a surrounding area of the through-opening 13 such that the through-opening 13 is closed to the inner side of the housing 10. Additionally or alternatively, the filling of the sealant 40 is introduced into a gap between the through-opening 13 and the busbar 30 passing therethrough, such that the housing 10 is closed in a gap around the busbar 30 in the through-opening 13.

The housing 10 is a multi-part housing 10, which has a housing cover 11 as well as a component boundary G, represented in FIG. 1, between a boundary surface 10g of the housing 10 and a boundary surface 11g of the housing cover 11. The filling of the sealant 40 is in contact with an inner surface of the housing 10 at least in a surrounding area of the component boundary G such that a gap of the component boundary G to the inner side of the housing 10 is closed. Additionally or alternatively, the filling of the sealant 40 is introduced into a gap between the boundary surface 10g of the housing 10 and the boundary surface 11g of the housing cover such that the housing 10 is closed in the gap of the component boundary G at the boundary surfaces 10g, 11g.

Alternatively, the battery storage device 100 can also have cylindrical or differently shaped battery cells 20 and the representative gas exit openings 16 can also exit from the housing 10 to another side and they do not have to lead to the outer side 17, but can initially lead into another housing section.

The above explanations of the embodiments describe the present invention exclusively within the context of examples. It goes without saying that individual features of the embodiments can be freely combined with one another, if technically feasible, without departing from the scope of the present invention.

### LIST OF REFERENCE NUMERALS

10 Housing
10g Boundary surface of the housing at component boundary
11 Housing cover
11g Boundary surface of the housing cover at component boundary
12 Interior
13 Through-opening
14 Housing section filled with sealant
15 Battery cell carrier
16 Gas exit openings
17 Outer side
20 Battery cells
23 Cell contacts
30 Busbar
31 Potential connections
40 Sealant
100 Battery storage device
G Component boundary between housing and housing cover
D Plane of the top view in FIG. 2
S Plane of the sectional view in FIG. 1

1. Battery storage device (100), having:
a housing (10) for receiving a number of battery cells (20);
at least one gas exit opening (16), which leads through the housing (10), for expelling gas releases from the battery cells (20) from an interior (12) of the housing (10) to an outer side (17) of the housing (10); and
at least one busbar (30) for the common electrical connection of the battery cells (20) in the housing (10) with a potentional connection (31), which is arranged on the outer side (17) of the housing (10);
characterised in that
a sealant (40) is arranged at a through-opening (13) which leads through the housing (10) and through which the busbar (30) passes between the interior (12) and the outer side (17) of the housing (10).

2. Battery storage device (100) according to claim 1, wherein the sealant (40) is in contact with an inner surface of the housing (10) in a region enclosing the through-opening (13), and encloses the busbar (30) in the housing (10) at least in sections.

3. Battery storage device (100) according to claim 1, wherein the sealant (40) fills a circumference of the through-opening (13) and encloses the busbar (30) in the through-opening (13).

4. Battery storage device (100) according to claim 1, wherein the busbar (30) is arranged in a housing section (14) between the plurality of the battery cells (20), which are arranged in the interior (12) of the housing (10), and a housing wall.

5. Battery storage device (100) according to claim 4, wherein the sealant (40) substantially fills the housing section (14) and substantially encloses the busbar (30) and seals the interior (12) of the housing (10) in a gas-tight manner with respect to the outer side (17).

6. Battery storage device (100) according to claim 1, wherein the housing (10) is composed of at least two housing elements (10, 11) at a component boundary (G), and the sealant (40) is in contact with an inner surface of the housing (10) in a region enclosing the component boundary (G), for gas-tight sealing of the housing (10) to an inner side of the component boundary (G) between the housing elements (10, 11).

7. Battery storage device (100) according to claim 1, wherein the housing (10) is composed of at least two housing elements (10, 11) at a component boundary (G), and the sealant (40) is arranged between opposite boundary surfaces (10g, 11g) of the housing elements (10, 11) for gas-tight sealing of the interior of the housing (10) at the component boundary (G) between the housing elements (10, 11).

8. Battery storage device (100) according to claim 1, wherein the sealant (40) comprises an inorganic, in particular mineral filler.

9. Battery storage device (100) according to claim 1, wherein the sealant (40) comprises a silicon oxide-based ceramic composite.

10. Battery storage device (100) according claim 1, wherein the sealant (40) comprises a high temperature-resistant binder.

11. Battery storage device (100) according to claim 1, wherein the sealant (40) has an adhesive property or is an adhesive.

12. Battery storage device (100) according to claim 1, wherein the sealant (40) has an electrically insulating property.
